(19) United States
(12) Patent Application Publication
(10) Pub. No.: US 2003/0186643 A1
(43) Pub. Date: Oct. 2, 2003

(54) Heating and air conditioning device comprising fragrance-supplying means in a vehicle passenger compartment

(76) Inventors: Vincent Feuillard, Le Mesnil St Denis (FR); Nathalie Lemaitre, Viroflay (FR)

Correspondence Address: Liniak Berenato, Longacre & White, Suite 240, 6550 Rock Spring Drive, Bethesda, MD, 20817, US

(21) Appl. No.: 10/275,808

(22) PCT Filed: Oct. 9, 2001
(86) PCT No.: PCT/FR01/03114

(30) Foreign Application Priority Data
Oct. 17, 2000 (FR) 00 13282

(51) Int. Cl. B60H 3/02

(52) U.S. Cl. 454/157

(57) ABSTRACT

The invention concerns a vehicle heating and/or air conditioning device comprising a housing (4) emerging into the passenger compartment, a fan (18) for sucking in an air flow into the housing (4) and for blowing it into the vehicle passenger compartment, fragrance-supplying means comprising a case (40) containing an amount of one or several perfuming agents fixed on a support (44) housed in the case (40) and capable of releasing a fragrance. The case (40) comprises a diffusing zone perforated with passages (42) allowing through an air flow. The support (44) of the perfuming agent is mobile between a diffusing position and a storage position wherein the perfuming agent is isolated from the diffusing zone by a barrier proof against the perfuming agent vapour.

The invention relates to devices for supplying fragrance to the cabin of a motor vehicle.

The interior of a car constitutes a closed space. In summer and in winter, when the car windows are closed and the air-conditioning system is used to cool or to heat the interior of the cabin, perspiration from the driver and the passengers, and cigarette smoke which accumulates in the cabin and in the ducts of the heating unit and of the air-conditioning system give rise to unpleasant smells. These smells may also originate from outside the air-conditioning system, for example from exhaust gases, or alternatively from the plastics and adhesives used in the cabin. In consequence, it is known practice for vehicles to be equipped with equipment whose main functions are to eliminate or to mask the smells, but which also have the function of affording other effects, for example physiological ones, etc. The invention relates to a device of such a type.

More specifically, the invention relates to a device for heating and/or air-conditioning the cabin of a motor vehicle, comprising a unit having an upstream end and a downstream end opening into the cabin, a fan for drawing a stream of air into the unit via the upstream end and for blowing it into the cabin via the downstream end of the unit, fragrance-supplying means comprising a casing containing a quantity of one or more aromatic agents which are fixed on a support housed in the casing and able to release a fragrance, the casing comprising a zone for diffusing the aromatic agent, which zone is pierced with at least one through-orifice to allow the air stream to pass through the casing. The term aromatic vapor is intended here to denote a perfumed substance able to give off an aromatic vapor commonly known as a fragrance.

Fragrance-supplying devices of this type are already known. The KOKAI Japanese document No. 58-81817 describes a fragrance-supplying device comprising a cassette containing a volatile aromatic agent situated as a branch of the unit of the heating and air-conditioning device.

U.S. Pat. Nos. 5,429,180 and 5,297,988 each describe a device for supplying fragrance to the cabin of a vehicle, comprising logic circuits for controlling the rate of flow of aromatic agent in the unit.

These known devices have the disadvantage of being complicated both to manufacture and to use.

The present invention remedies these drawbacks. It proposes a cabin heating and air-conditioning device comprising fragrance-supplying means which are simple to manufacture and to use.

To this end, the support of the aromatic agent or aromatic agents can move between at least one diffusing position in which the aromatic agent or one of the aromatic agents faces the diffusion zone, and a storage position in which the aromatic agent is isolated from the diffusion zone by a barrier impervious to the fragrance, the device comprising a control which allows an operator situated in the cabin of the vehicle to move the moving support between the diffusing position and the storage position.

Thus, the fragrance-supplying device of the invention is simple to manufacture. It comprises only mechanical parts except for any logic control circuit. Furthermore, it is simple to use, it being possible to switch the device on and off manually from the dashboard using a rotary nozzle, a sliding switch or a push button. In the same way, if the device comprises several aromatic agents, the aromatic agent can be chosen using the same rotary knob, sliding switch or push button.

According to one alternative form of the embodiment, the support can move in translation. In one particular embodiment, the casing consists of a tube and the moving support consists of a rod slidably mounted in the tube, at least one aromatic agent being mounted on the sliding rod and at least one separating disk forming a barrier impervious to the vapor of the aromatic agent being provided on the sliding rod so as to isolate the aromatic agent or the aromatic agents from the diffusing zone.

In another alternative form of the embodiment, the support can move in rotation. In one particular embodiment, the rotary support is a disk comprising a number of angularly spaced housings, each housing being able to contain an aromatic agent.

In another alternative form of the embodiment, the rotary support is a cylinder comprising perforations in two opposed zones and mounted so that it can rotate about a longitudinal axis, this cylinder containing a quantity of at least one aromatic agent, and the casing comprising at least two diametrically opposed orifices constituting a zone for diffusing the aromatic agent, it being possible for the rotary support to be moved angularly between a diffusing position in which the perforations of the cylinder face the diffusing zone of the casing, and a storage position in which the perforations of the cylinder are angularly offset from the diffusing zone.

Often, the heating and/or air-conditioning unit comprises an air filter which allows the atmospheric air drawn in from outside the vehicle to be filtered. In such a case, the casing is advantageously built into the air filter.

As a preference, each aromatic agent is in the form of a solid cartridge because such cartridges are easier to handle.

In one particular embodiment, the device comprises a module situated on the dashboard of the vehicle and incorporating the casing, the latter being connected to the unit by an air inlet duct connected downstream of the fan and by an air outlet duct connected downstream of the air inlet duct. As a preference, the air outlet duct is connected to a mixing zone of the unit of the heating and/or air-conditioning device.

Advantageously also, the module comprises an access hole in its front which is accessible to the driver or to a passenger of the vehicle, this access hole allowing the cartridge or cartridges of aromatic agent to be replaced.

According to another feature of the invention, the device comprises means for displaying which aromatic agent has been selected.

Further features and advantages of the present invention will also become apparent from reading the description which follows of some exemplary embodiments which are given by way of illustration with reference to the appended figures. In these figures:

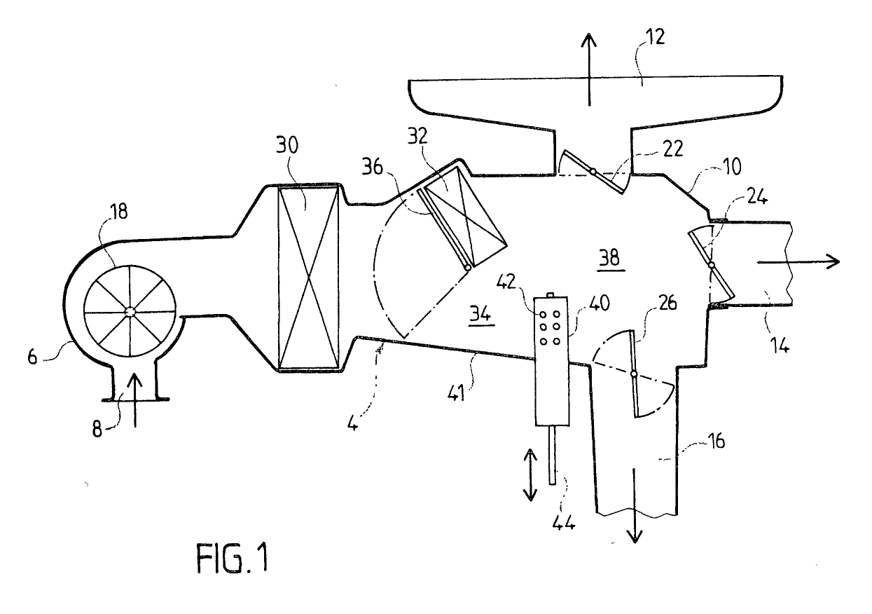

FIG. 1 is an overall schematic view of a heating and/or air-conditioning device according to the invention;

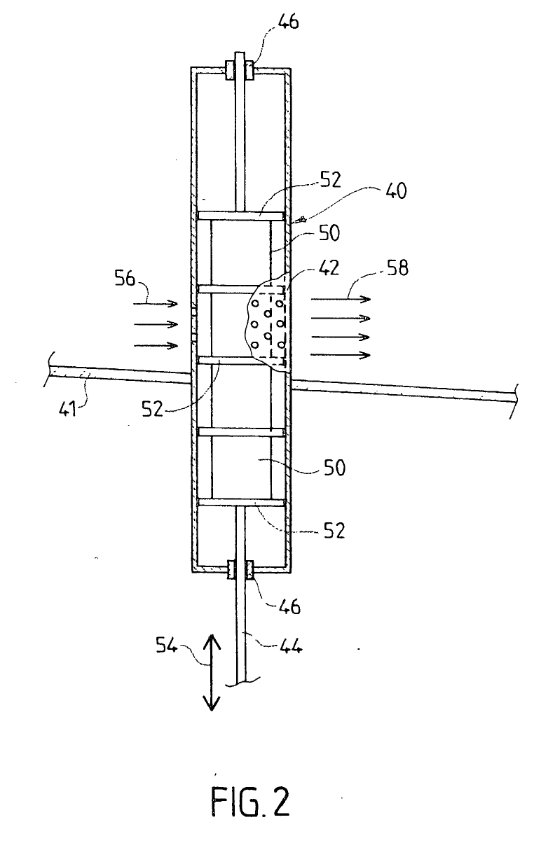

FIG. 2 is a detailed view of the fragrance-supplying means of the device depicted in FIG. 1;

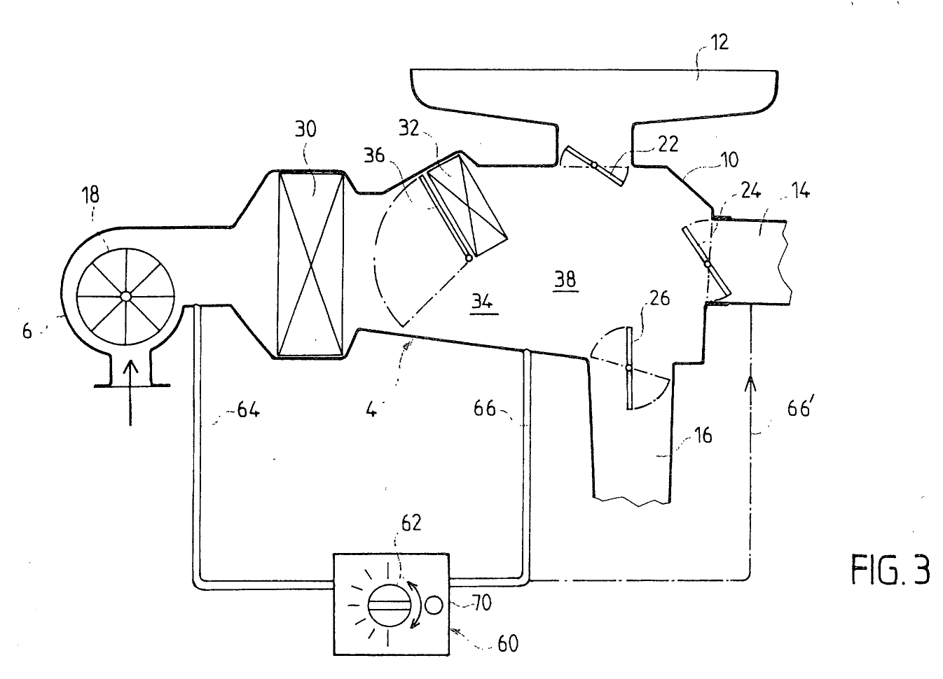

FIG. 3 is an overall schematic view, similar to FIG. 1, of an alternative form of the embodiment of the invention;

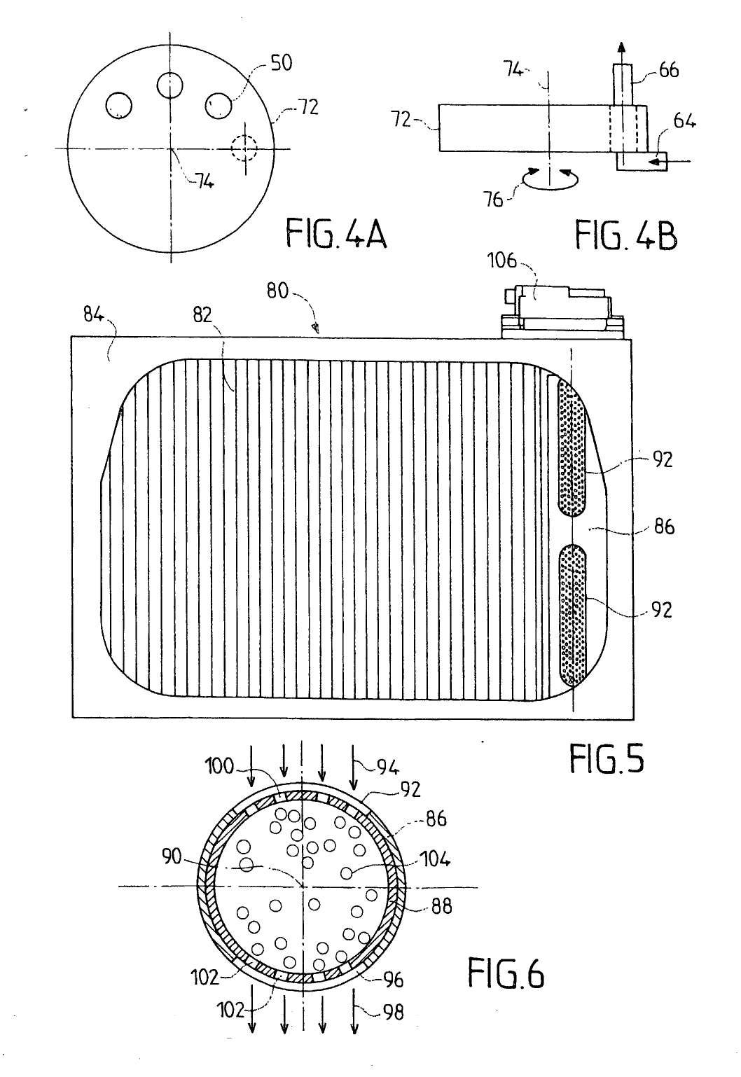

FIGS. 4a and 4b are, respectively, a front view and an elevation of a moving support in the form of a disk which can be used in the alternative form of the embodiment of the device depicted in FIG. 3;

FIG. 5 is a view of an air filter incorporating a moving cylinder containing an aromatic agent;

FIG. 6 is a view in section, on a larger scale, of the cylinder depicted in FIG. 5; and

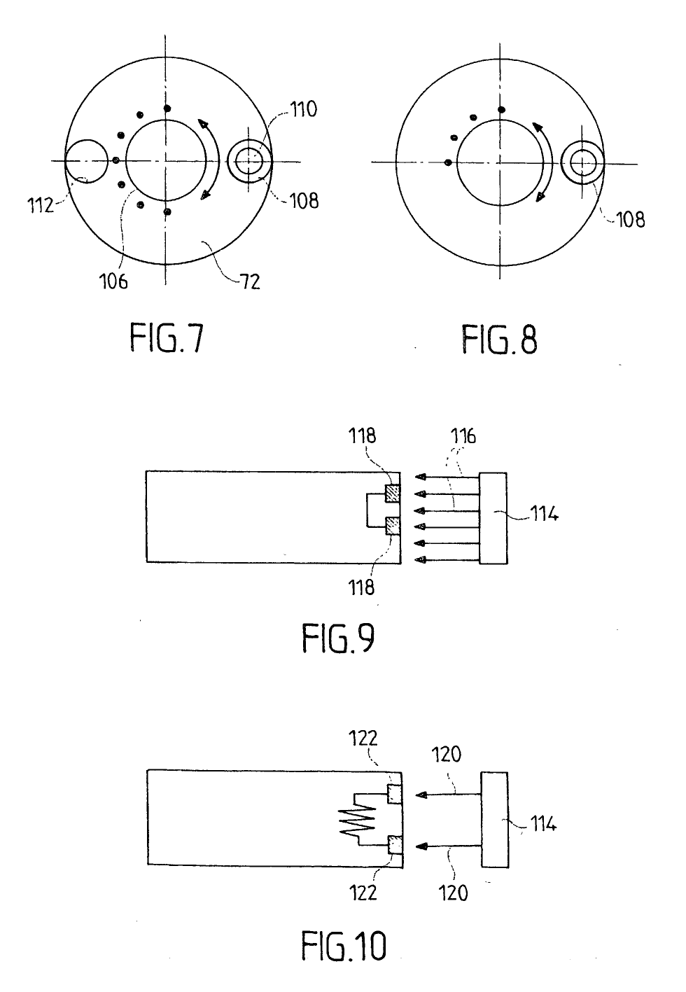

FIGS. 7 to 10 depict various means of displaying and/or recognizing which aromatic agent has been selected.

In FIG. 1, the unit 4 of the heating device comprises an upstream end 6 comprising an air inlet opening 8 and a downstream end 10 comprising three air outlets opening into the vehicle cabin, namely, respectively, an air outlet 12 for demisting the windshield, an air outlet 14 for ventilating and/or heating the cabin and an outlet 16 for warming the feet of the driver and of the passengers. A fan 18 driven by an electric motor (not depicted) draws air in through the inlet 8 and creates an air stream in the unit 4. Shutters 22, 24 and 26 regulate the amount of air passing through each of the air outlets 12, 14 and 16 respectively.

An evaporator 30 forming part of an air-conditioning circuit, is mounted in the heater unit 4 immediately downstream of the fan 18. The air stream is cooled as it passes across the evaporator 30.

A heater matrix 32 incorporated into the cooling circuit of the motor vehicle (not depicted) is also mounted in the heater unit 4. The air stream passing through the unit is heated as it passes across the heater matrix 32. The matrix 32 is mounted in the unit 4 in such a way that there is a bypass passage 34 which bypasses the heater matrix 32.

An air mixing shutter 36 is provided on the upstream side of the heater matrix 32. This shutter can be moved between a position depicted in solid line opening the bypass passage 34 and preventing the air stream from passing across the heater matrix 32, and a position depicted in chain line preventing the air stream from passing through the bypass passage 34 and forcing it to pass across this matrix, so that the air is heated up.

In an intermediate position, the ratio between the air stream passing across the matrix 32 and the air stream passing through the bypass passage 34 is regulated by the extent to which the shutter 36 is open so as to regulate the air temperature when the hot air stream and the cold air stream mix in a mixing zone 38. As an alternative, it is possible to use a device of the “mixing on the water” type, in which the flow rate of cooling liquid passing through the heater matrix can be adjusted, making it possible to regulate the temperature of the air stream leaving the matrix.

A casing 40 having the overall form of an elongate cylinder passes through a wall 41 of the heater unit 4. The casing 40 comprises a part situated inside the mixing zone 38 and a part situated outside the unit 4. The part of the casing 40 situated in the mixing zone is pierced with orifices 42 forming a diffusing zone. Outside the unit there is a rod 44 constituting a control means. In an alternative form, the casing 40 could be housed completely inside the wall 41 and mounted on an external rod 44.

FIG. 2 depicts a view on an enlarged scale of the casing 40 mounted on the wall 41. The casing 40 has, passing right through it, a rod 44 slidably mounted on two bearings 46 situated at each of the ends of the casing. Several cartridges of aromatic agent or perfume, three in the exemplary embodiment depicted, are mounted on the rod 44. A location without a cartridge is provided to form a storage or off position. It is, however, possible to omit this off position by adding a fourth cartridge of perfume to the abovementioned empty space. Each cartridge 50 is placed between two disks 52, also mounted on the rod 44 and forming a sealed sliding connection with the interior cylindrical wall of the casing 40.

The cartridges of aromatic agent 50 are preferably solid; it is possible to have as many perfumes as there are cartridges, or alternatively, two cartridges of each perfume may be provided, so as to allow a cartridge to be replaced when the previous one is used up. It is also conceivable to provide several cartridges of the same perfume. The rod 44 can be moved back and forth in translation as symbolized by the arrow 54 using control means (not depicted). Movement of the rod 44 has the effect of placing one of the cartridges of aromatic agent facing the perforations 42 made in a diffusing zone of the casing. Outside of this diffusing zone, the casing 40 has no opening.

When a cartridge 50 of aromatic agent is placed in the diffusing zone, as depicted in FIG. 2, the two disks 52 situated on each side of the cartridge of aromatic agent form an airtight chamber which is also impervious to the fragrance of the aromatic agent. Given that the casing is placed in the path of the air stream set in motion by the fan 18 of the heater unit 4, the air enters via the perforations 42, as depicted schematically by the arrows 56, crosses the chamber defined between the two disks 52, carrying with it the vapor of the aromatic agent. The air then leaves through the opposite side of the casing as depicted by the arrows 58, then enters the cabin via one of the air outlets 12, 14 and 16 (see FIG. 1). The vehicle cabin is thus fragranced. The fragrance is changed easily, simply by moving the rod 44, which allows another aromatic agent to be brought opposite the perforations 42 of the diffusing zone of the casing. It is also possible not to diffuse any fragrance by not placing any cartridge of aromatic agent in the diffusing zone.

FIG. 3 depicts an alternative form of the embodiment of a device according to the invention similar to the one described with reference to FIGS. 1 and 2. Elements which are identical have been denoted by identical reference numbers. This alternative form differs in that it comprises a module 60 mounted on the dashboard of the vehicle and accessible to the driver and to the passengers. The casing (not depicted) which contains the cartridges of fragrance is arranged inside the module 60, just behind the front face of the dashboard. An air inlet duct 64 connects part of the heater unit 4 to the casing, while an air outlet duct 66 connects this casing to part of the unit situated downstream of the first. The module 60 can be placed at some other location accessible for refilling, for example under the dashboard.

In the exemplary embodiment described, the air inlet duct 64 is connected to the unit 4 just after the fan 18, upstream of the evaporator 30. The air outlet duct 66 opens at the mixing zone 38. The ducts 64 and 66 thus form a bypass to the main heating and air-conditioning circuit. Some of the air stream set in motion by the fan 18 passes through this bypass, carrying with it the fragrance of the aromatic agent placed in the diffusing zone of the casing. This air is conveyed as far as the mixing zone 38 before it enters the cabin via one of the three air outlets 12, 14 and 16, as described previously. In an alternative form of the embodiment, the air outlet duct 66 may be connected directly to the ventilation air outlet 14.

This embodiment is advantageous because air laden with the fragrance of the aromatic agent does not pass through the evaporator. Now, when the air stream passes through the evaporator, some of the vapor it contains condenses on account of its cooling. The liquid resulting from this condensation is discharged to outside the vehicle. If the air laden with aromatic agent were to pass through the evaporator, some of it would be discharged to the outside as a pure loss. The fragrance trapped on the surface of the evaporator may create a remanence which remains perceivable even when the fragrance supplying device is switched off.

In the exemplary embodiment depicted in FIG. 3, the support of the cartridges of aromatic agent is mounted so that it can move in rotation. A knob 62, accessible on the dashboard, is mounted directly on the rotation spindle of the moving support of the fragrances. Through a simple turning motion, the driver of the vehicle or a passenger can select one of the cartridges of fragrance available, a refill cartridge when the previous cartridge is used up, or may alternatively switch off the fragrance-supplying device by selecting no cartridge. The module 60 also comprises an access hole 70 which allows the cartridges of fragrance to be replaced easily from the vehicle cabin. All that is required is for the rotary knob 62 to be turned so as to bring the cartridge that is to be replaced to face the access hole 70, for it to be withdrawn and for a fresh cartridge to be inserted.

FIGS. 4a and 4b depict a front view and an elevation of the support of the cartridges of aromatic agent 50. This support 72 has the form of a thick disk in which angularly spaced circular housings for accommodating several cartridges of fragrance are provided. One of the locations contains no cartridge, so as to allow the fragrance-supplying device to be switched off. The support 72 can move in rotation, as depicted schematically via the arrow 76, about an axis 74 depicted in chain line. The air stream enters via the air conveying duct 64, crosses the disk carrying with it the fragrances of the aromatic agent, and re-emerges through the air outlet duct 66, as described previously with reference to FIG. 3.

FIGS. 5 and 6 depict a third alternative form of the embodiment of the invention. In general, the air drawn into the heater unit is filtered because it comes from the external surroundings and is therefore laden with dust and particles. This air passes through a dust filter consisting of a nonwoven medium 82 made of synthetic or cellulose fibers and arranged in a support made of plastic or metal 84.

According to the invention, a fragrance-supplying device is built into this filter. It comprises two coaxial cylinders, namely a fixed first cylinder 86 and a second cylinder 88 mounted so that it can turn inside the cylinder 86 about an axis 90 (see FIG. 6). The cylinder 86 is pierced with one or more apertures 92 situated on the air stream inlet side, depicted schematically by the arrows 94. It also comprises one or more apertures 96 diametrically opposite the aperture or apertures 92, so as to allow the air stream out, as depicted schematically by the arrows 98. The moving cylinder 88 comprises a first zone provided with perforations 100 and a second zone diametrically opposite the first, provided with perforations 102.

Housed inside the cylinder 88 is an aromatic agent which is, for example, in the form of beads or micro capsules 104. When the cylinder 88 is in the angular position depicted in FIG. 6, air enters via the perforations 100, crosses the cylinder 88, circulating through the beads or microcapsules 104, and re-emerges via the diametrically opposite perforations 102, passing through the aperture 96 in the fixed cylinder 86. As before, the air stream carries with it the fragrances of aromatic agent given off by the beads or microcapsules 104.

The cylinder 88 can be turned angularly through 90° so that the perforations 100 and 102 face a zone of the fixed cylinder 86 which has no openings and so that the two zones on the moving cylinder 88 which are situated between the perforated zones 100 and 102 face the apertures 92 and 96. The cylinder can also turn through 60° or through 45° so as to vary the intensity, in the case of a single fragrance, or to offer a choice between two or three fragrances. Thus, the aromatic agent contained in the cylinder 88 is isolated hermetically from the air stream and the fragrance-supplying device is switched off. A geared motor unit 106 mounted on the support 84 of the filter allows the moving cylinder 88 to be turned between these two positions.

It is noted that in this alternative form of embodiment, just one fragrance is available and that the only possible adjustment is to switch the device on or off. The geared motor unit 106 is controlled electrically from the vehicle dashboard.

According to the invention, it is advantageous for the support 44, 72 or 88 of the aromatic agent to be situated after the evaporator 30, after the heater matrix 32 and before the air outlets 12, 14 and 16 opening into the cabin of the vehicle.

In the form of the embodiment of FIG. 7, the support 72 is similar to that of FIGS. 4a and 4b. It is in the form of a disk in which circular housings are provided for accommodating fragrance cartridges.

This support can be turned by a knob 106 accessible from the dashboard (not depicted) of the vehicle. This dashboard comprises a transparent window 108 which makes it possible to view a symbol 110 (for example a patch of color) identifying the aromatic agent used. Furthermore, the dashboard has an access hatch 112 which allows a used cartridge to be replaced.

It is thus possible directly to display a symbol that represents which aromatic agent is being used.

FIG. 8 constitutes an alternative form of the previous embodiment, the difference being that the window 108 also acts as an access hatch for replacing the cartridge. As a result, the window 112 of FIG. 7 is purely and simply omitted.

In certain instances, the cartridge is not placed directly behind the dashboard and remote display and recognition means are provided.

For example, it is possible to provide a housing corresponding to a given aromatic agent, the cartridge being recognized for example using polarizing means.

In the embodiment of FIG. 9, recognition of a fragranced cartridge is through electronic means comprising a detector 114 with contact lines 116 for recognizing contacts 118 of the cartridge by electrical continuity.

In the case of FIG. 10, the detector 114 comprises two contacts 120 which can collaborate with two contacts 122 of a fragranced cartridge.

Of course, it is possible to envision other types of means for recognizing and displaying the type of aromatic agent selected.

The aromatic agent of the invention may be a liquid fragrance impregnated onto an appropriate support which is advantageously chosen from chalks, clays, papers, blotters, wovens and nonwovens, pot-pourri sachets, plastic beads (for example formed of a polyethylene/polypropylene blend), wooden or glass beads, etc.

As an alternative, the aromatic agent can be mixed by way of constituent, with supports such as gels, microcapsules, powders, elements made of plastic, etc.

The chemical nature of the aromatic agent depends on the desired objective in fragrancing the vehicle. In particular, at least one of the following effects may be afforded.

Physiological effect: passifying, relaxing, toning, etc.

Example: zesty smell (limonene, citral) or terpenic smell (camphor, menthol).

Image effect: the olfactory signature of a make of vehicle or style of vehicle (luxury, sports, family, etc.).

Examples: masculine wood smell (vetyveryl acetate, ambroxan) or gentle playful smell (benzyl benzoate, vanillin, coumarin, trans-anethol) or fruity smell (undecalone, citral).

Fashionable effect: to do with the fragrances used in fine or technical perfumery of the day.

Personalized effect: offering the user a broad spectrum to suit his taste.

There has thus been produced a heating and air-conditioning device comprising fragrance-supplying means which are simple to manufacture, to incorporate and to use and which, in certain alternative forms, comprise several fragrances or scents which can easily be selected.

1. A device for heating and/or air-conditioning the cabin of a motor vehicle, comprising a unit (4) having an upstream end (6) and a downstream end (8) opening into the cabin, a fan (18) for drawing a stream of air into the unit (4) via the upstream end and for blowing it into the cabin via the downstream end of the unit (4), fragrance-supplying means comprising a casing (40) containing a quantity of one or more aromatic agents (50) which are fixed on a support (44, 72, 88) housed in the casing (50, 86) and able to release a fragrance, the casing (50, 86) comprising a zone for diffusing the aromatic agent, which zone is pierced with at least one through-orifice (42, 92, 96) to allow the air stream (56, 58) to pass through the casing,
characterized in that the support (44, 72, 88) of the aromatic agent can move between at least one diffusing position in which the aromatic agent or one of the aromatic agents faces the diffusion zone, and a storage position in which the aromatic agent is isolated from the diffusion zone by a barrier (52) impervious to the fragrance of the aromatic agent, the device comprising a control (44) which allows an operator situated in the cabin of the vehicle to move the moving support (44, 72, 88) between the diffusing position and the storage position.

2. The device as claimed in claim 1, characterized in that the support (44) can move in translation.

3. The device as claimed in claim 2, characterized in that the casing consists of a tube (40) and the moving support consists of a rod (44) slidabley mounted in the tube (40), at least one aromatic agent (50) being mounted on the sliding rod (44) and at least one separating disk (52) forming a barrier impervious to the vapor of the aromatic agent being provided on the sliding rod (44) so as to isolate the aromatic agent or the aromatic agents from the diffusing zone.

4. The device as claimed in claim 1, characterized in that the support (72) can move in rotation.

5. The device as claimed in claim 4, characterized in that the rotary support is a disk (72) comprising a number of angularly spaced housings, each housing being able to contain an aromatic agent (50).

6. The device as claimed in claim 5, characterized in that the rotary support is a cylinder (88) comprising perforations (100, 102) in two opposed zones and mounted so that it can rotate about a longitudinal axis (90), this cylinder containing a quantity of at least one aromatic agent, and in that the casing (86) comprises at least two diametrically opposed orifices (92, 96) constituting a zone for diffusing the aromatic agent, it being possible for the rotary support (88) to be moved angularly between a diffusing position in which the perforations of the cylinder face the diffusing zone of the casing, and a storage position in which the perforations of the cylinder (88) are angularly offset from the diffusing zone.

7. The device as claimed in claim 6, characterized in that it comprises an air filter (80) and in that the casing (86) is built into the air filter (80).

8. The device as claimed in one of claims 1 to 7, characterized in that the aromatic agent is in the form of a solid cartridge.

9. The device as claimed in one of claims 1 to 8, characterized in that it comprises a module (60) situated on the dashboard of the vehicle and incorporating the casing (40), the latter being connected to the unit (4) by an air inlet duct (64) connected downstream of the fan (18) and by an air outlet duct (66) connected to the unit (4) downstream of the air inlet duct (64).

10. The device as claimed in claim 9, characterized in that the air outlet duct (66) is connected to a mixing zone (38) of the unit (4) of the heating device.

11. The device as claimed in one of claims 7 to 10, characterized in that the module (60) comprises an access hole in its front (70) which is accessible to the driver or to a passenger of the vehicle, this access hole (70) allowing the cartridges (50) of aromatic agent to be replaced.

12. The device as claimed in one of claims 1 to 11, characterized in that it comprises means (108, 110; 114) for displaying which aromatic agent has been selected.

13. The device as claimed in one of claims 1 to 12, characterized in that it further comprises an evaporator (30) and in that the support (44, 72, 88) of the aromatic agent is situated after the evaporator.

14. The device as claimed in claim 13, characterized in that it further comprises a heater matrix (32), and in that the support (44, 72, 88) of the aromatic agent is situated after the heater matrix.

15. The device as claimed in either of claims 13 and 14, characterized in that it further comprises air outlets (12, 14, 16) opening into the vehicle cabin, and in that the support (44, 72, 88) of the aromatic agent is situated before the air outlets into the vehicle.
